(19) United States
(12) Patent Application Publication
(10) Pub. No.: US 2024/0311964 A1
(43) Pub. Date: Sep. 19, 2024

(54) SYSTEM AND METHOD FOR FIELD OF VIEW EXTENSION BY SUPER RESOLUTION

(71) Applicant: Black Sesame Technologies Inc., San Jose, CA (US)

(72) Inventor: Bo Li, Singapore (SG)

(21) Appl. No.: 18/121,884

(22) Filed: Mar. 15, 2023

(51) Int. Cl. G06T 3/40; G06V 10/25; G06V 10/44; G06V 10/56; G06V 10/74; G06V 10/82

(52) U.S. Cl. CPC G06T 3/4076; G06V 10/25; G06V 10/44; G06V 10/56; G06V 10/761; G06V 10/82

(57) ABSTRACT

The invention discloses an image field of view extension using camera images of various quality and different overlapping field of views. By using a learning algorithm, the invention compares common points between the two images and makes calculations online and offline to a low-resolution, larger image so that the final image with a large field of view and high resolution. The invention provides strong adaptive capabilities to different input images while still providing a quality final image.

### FIELD OF THE INVENTION

The present invention relates to combining and fusing images of varying quality and different overlapping field of views (FOVs) to provide view extension using super resolution. Specifically, the present invention can maintain a quality image from a high-quality sensor and improve a quality of an image with a overlapping region of interest of a low-quality sensor with a larger FOV based on calibration information.

### BACKGROUND

Developments in imaging technology have led to significant improvements in multiple camera systems. To unify different camera information, systems have used a super resolution imaging approach that combines information from multiple low-resolution images with subpixel displacements to obtain a higher resolution image. Super resolution arises in several fields, such as remote sensing, surveillance, and an extensive set of consumer electronics, such as automobile systems and mobile phones.

However, several problems arise with the super resolution method which aims to estimate a higher resolution image than is present in any of the individual images. These lower resolution images have degradation which typically include geometric warping, optical blur, spatial sampling, and noise. Additionally, another set of issues occur when the camera sensors are not identical, including: 1) inconsistencies between colors of images from different sensors; 2) low quality of image pixelation from large FOV in a low-quality sensor; and 3) texture misalignment and inconsistency between low quality and high quality images.

For example, previous methods use a burst of raw images to be captured. For every captured frame, the system aligns it locally with a single frame from the larger burst base frame. Next, the system estimates each frame's local contributions through kernel regression and accumulates those contributions across the entire burst frame. The contributions are accumulated separately per color plane. Next, the kernel shapes are adjusted based on the estimated signal features and weigh the sample contributions based on a robustness model. Lastly, a per-channel normalization occurs to obtain the final merged RGB image. These methods often require multiple aliased images as different offsets and that the input frames to be aliased, i.e., contain high frequencies that manifest themselves as false low frequencies after sampling. This places undue restrictions on the camera sensors and limits flexibility.

Other systems use deep learning based super resolution. For example, deep convolution networks may be used as a post-processing model of a traditional scaler to enhance details of the images and video resized by conventional methods such as bilinear, bicubic, Lanczos filters, etc. However, this may introduce a large computation workload to an inference device, especially when the input resolution of the images or videos is high.

Another way to achieve higher quality output is to directly take a low resolution image or video frame as input, and then utilize a convolutional network to restore the details of high resolution images. For example, the convolutional network can be used to apply a series of neural network layers first to the low-resolution video frames to exact import feature maps used to restore high resolution details. After that, a dedicated neural network layer may upscale the low-resolution feature maps to a high resolution image.

The prior art described above places restrictions on the type and quality of the sensors used to aggregate the multi-images in super resolution. There are many instances where the use of camera sensors of different qualities and FOV size are beneficial or even necessary. Therefore, to overcome the shortcomings of the prior art, there is a need to provide an adaptable solution which can account for cameras of varying quality while still providing a method to process a super resolution image of high quality.

### SUMMARY

An objective of the invention is to combine and fuse multiple images to form high quality and large FOV images. Distinct from the traditional super resolution method, this invention maintains the region of interest from a high quality camera and improves the quality of ROI from a low quality camera, which usually has a larger FOV based on calibration information.

In one aspect described herein, a method for FOV extension is described by receiving a first image from a main camera and a second image from at least one auxiliary camera; and determining an overlapping region of interest between the first image and the second image. The steps also may include generating feature point pair within the overlapping region of the first image and the second image. Following generating the pair, the steps may include performing color remapping compensation learning and super resolution frequency compensation learning using the feature point pair; and applying the data set to change to the second image to generate a target resultant image.

The invention further discloses that performing a color remapping compensation learning and performing a super resolution frequency compensation learning may be both executed offline or online. Further adaptations may include using mesh warping alignment, a convolution neural network, and the Hue/Saturation/Value color scheme. When generating feature point pair, a homography matrix may be used to map the feature point pairs. Among the various specification differences between cameras, the FOV of the first image may be smaller than the FOV of the second image and pixel frequency of the first image is higher than the pixel frequency of the second image.

The invention further discloses a non-transitory computer readable medium including code segments that when executed by a processor cause the processor to perform the steps of: receiving a first image from a main camera and a second image from at least one auxiliary camera; determining an overlapping region of interest between the first image and the second image; generating feature point pair within the overlapping region of the first image and the second image; performing a color remapping compensation learning using the feature point pair; performing a super resolution frequency compensation learning using the feature point pair; and applying changes to the second image to generate target resultant image.

The invention further discloses an apparatus for the field of view (FOV) extension which may comprise a main camera, at least one auxiliary wide camera, and one or more processors. The processors incorporate a comparator for feature pair matching; a color remapping module for color compensation; and a super resolution module for frequency compensation between the images. The main camera and the auxiliary wide cameras may have different resolution qualities and field of views. Also, the processor may perform the color remapping module and the super resolution module in multiple iterations prior to forming a resultant image. Similar to the disclosed method, the color remapping module and the super resolution module may be performed both online and offline.

Other objectives and aspects of the invention will become apparent from the following detailed description, taken in conjunction with the accompanying drawings, which illustrate, by way of example, the features in accordance with several embodiments of the invention.

To the accomplishment of the above and related objects, this invention may be embodied in the form illustrated in the accompanying drawings, attention being called to the fact, however, that the drawings are illustrative only, and that changes may be made in the specific construction illustrated and described within the scope of the appended claims.

Although, the invention is described above in terms of various exemplary embodiments and implementations, it should be understood that the various features, aspects, and functionality described in one or more of the individual embodiments are not limited in their applicability to the particular embodiment with which they are described, but instead can be applied, alone or in various combinations, to one or more of the other embodiments of the invention, whether or not such embodiments are described and whether or not such features are presented as being a part of a described embodiment. Thus, the breadth and scope of the present invention should not be limited by any of the described exemplary embodiments.

### BRIEF DESCRIPTION OF THE DRAWINGS

The objects and features of the present invention will become more fully apparent from the following description and appended claims, taken in conjunction with the accompanying drawings. Understanding that these drawings depict only typical embodiments of the invention and are, therefore, not to be considered limiting of its scope. The illustrative embodiments, however, as well as a preferred mode of use, further objectives and descriptions thereof, will best be understood by reference to the following detailed description of an illustrative embodiment of the present disclosure when read in conjunction with the accompanying figures, wherein:

FIG. 1 illustrates an example system diagram in accordance with an embodiment of the disclosure;

FIG. 2 illustrates a flowchart of the FOV extension by super resolution in accordance with an embodiment of the disclosure;

FIG. 3 illustrates camera global alignment using feature point matching in accordance with an embodiment of the disclosure;

FIG. 4 illustrates an example of the mesh alignment warping in accordance with an embodiment of the disclosure;

FIG. 5 illustrates an example of the offline compensation model in accordance with an embodiment of the disclosure;

FIG. 6 illustrates an example of the FOV expansion model process in accordance with an embodiment of the disclosure;

FIG. 7 illustrates a method for the FOV expansion model in accordance with an embodiment of the disclosure.

### DETAILED DESCRIPTION

Example methods, devices, and systems are described herein. It should be understood that the words “example” and “exemplary” are used herein to mean “serving as an example, instance, or illustration.” Any embodiment or feature described herein as being an “example” or “exemplary” is not necessarily to be construed as preferred or advantageous over other embodiments or features unless stated as such. Other embodiments can be utilized, and other changes can be made, without departing from the scope of the subject matter presented herein.

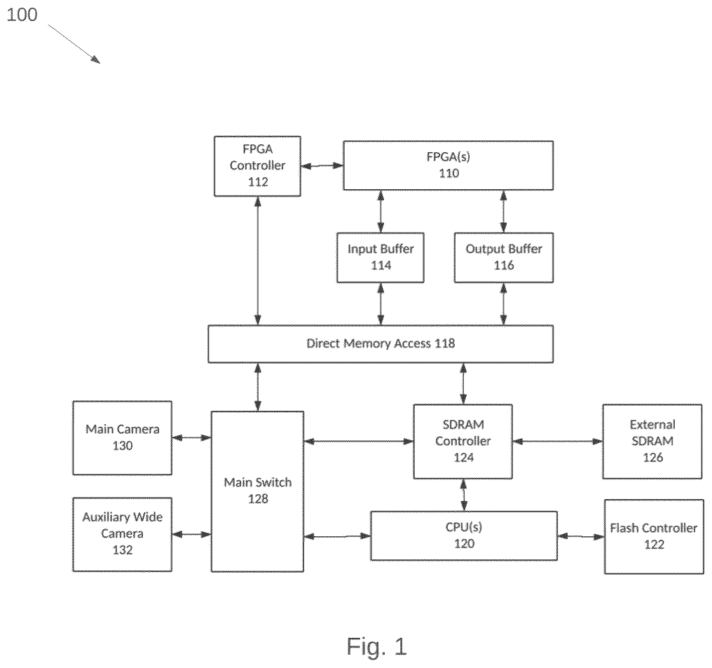

FIG. 1 depicts an example system 100 that may be used to implement neural nets associated with the operation of one or more portions or steps of process 200. In this example, the processors associated with the hybrid system comprise a field programmable gate array (FPGA) 110 and a central processing unit (CPU) 120.

The FPGA is electrically connected to an FPGA controller 112 which interfaces with a direct memory access (DMA) 118. The DMA is connected to input buffer 114 and output buffer 116, which are coupled to the FPGA to buffer data into and out of the FPGA respectively. The DMA 118 includes of two first in first out (FIFO) buffers one for the host CPU and the other for the FPGA, the DMA allows data to be written to and read from the appropriate buffer.

On the CPU side of the DMA are a main switch 128 which shuttles data and commands to the DMA. The DMA is also connected to an SDRAM controller 124 which allows data to be shuttled to and from the FPGA to the CPU 120, the SDRAM controller is also connected to external SDRAM 126 and the CPU 120. The main switch 128 is connected to the peripherals such as the main camera 130 and the auxiliary wide camera 132. A flash controller 122 controls persistent memory and is connected to the CPU 120.

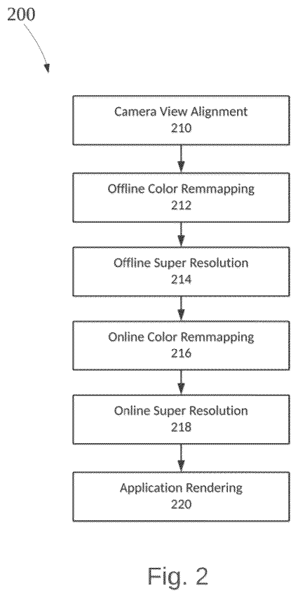

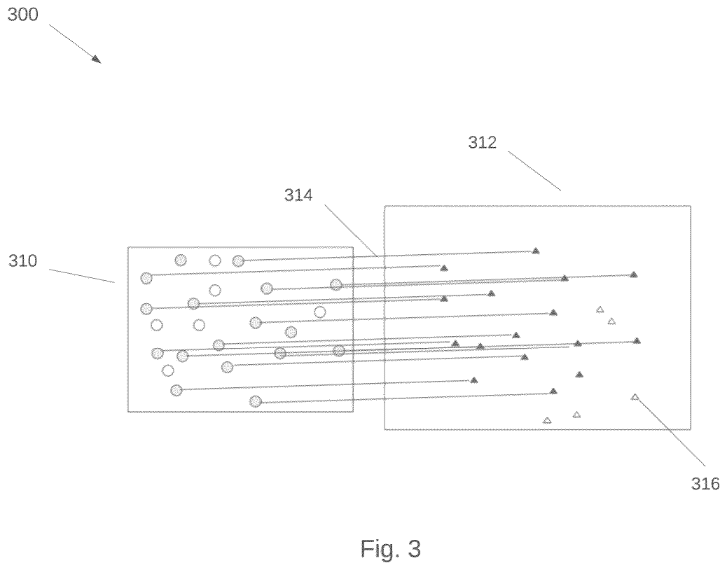

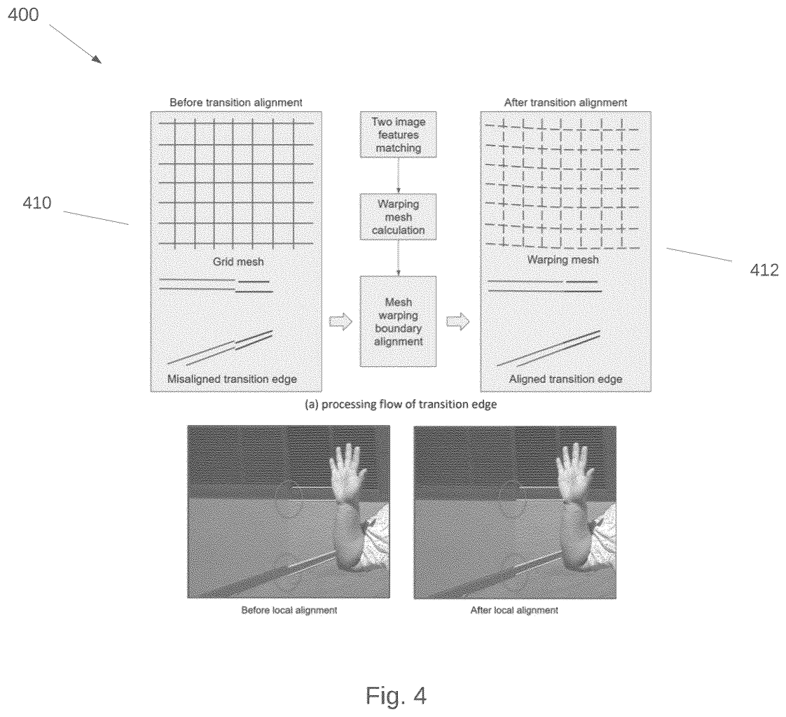

FIG. 2 illustrates a general flowchart of the FOV extension by super resolution. An offline and online learning system is used to extend the main camera FOV through super resolution with assistance from an auxiliary wide camera. The system takes images from the main camera and at least one auxiliary wide camera for camera view alignment 210. The camera view alignment 210 uses a two-step approach that includes global alignment using feature point matching 300 (See FIG. 3) and mesh alignment 400 (See FIG. 4) to improve the corresponding pixel-to-pixel relationship among camera images. The system then performs offline color remapping 212 and an offline super resolution 214 prediction. The information collected offline is used to train the system and build a training set. The system then performs online color remapping 216 and an online super resolution 218 prediction using learned online functions from corresponding pairs of overlapped regions between the main camera and auxiliary cameras. However, there may be some bias between immediate online capture and offline models training sets estimated by offline super resolution module over time. Therefore, the system takes the online and offline information and compensates the bias during application rendering 220.

FIG. 3 illustrates camera global alignment using feature point matching. For systems using multiple cameras, there are always pixel-level mismatching between images of different views. Because of differences in the quality of the camera or merely the different angle positions, the pixel-to-pixel correlation will vary. Misalignment or presence of different characteristics between two associated images creates discontinuity at the pixel level. The goal of the system is to minimize the discontinuity between the different images.

In the global alignment matching model using feature point matching 300, the system looks for a overlapping region of interest between the two cam images and generates feature point pairs 314 between the high pixel density main camera image 310 and the larger FOV auxiliary wide camera image 312. These feature point pairs provide a guide that will allow the system to further correct alignment between the two images. A homography model is calculated using a global alignment. Homography is a transformation method that provides correlation between two images by mapping points in one image to the corresponding points in another image. The system uses feature matching means finding corresponding features from two similar datasets.

$${H [ {x}_{1} , {y}_{1} , 1 ]}^{T} = {[ {x}_{2} , {y}_{2} , 1 ]}^{T}$$

$$H = [ {h}_{00} {h}_{01} {h}_{02} {h}_{10} {h}_{11} {h}_{12} {h}_{20} {h}_{21} {h}_{22} ]$$

Here, Matrix H is a 3 by 3 homography matrix which warps a feature point (x₁,y₁) from the image 312 captured by the auxiliary wide camera to a corresponding feature point (x₂,y₂) from the image 310 captured by the main camera to form a feature point pair. By creating multiple feature point pairs, the system builds accurate pixel correlations between the overlapping region of interests (ROI) while ignoring unassociated pixels 316. After performing global homography, a disparity will still remain due to local mismatching caused by the baseline image quality differences between the two cameras. Therefore, mesh alignment is performed to carry out local alignments to reduce mismatch issues.

FIG. 4 shows mesh alignment warping based on local alignment 400. Since there exists a different baseline between cameras of varying FOVs, pixels along the transition edge will inherently contain disparities. Since there is not a direct 1:1 correlation between the main camera and the auxiliary wide camera, these disparities result in a rigid misalignment 410 that destroys visual continuity in the final high resolution wide FOV output. Because of the misalignment, it's necessary to make a calculation to correct the misalignment between the matched feature points. The system applies a mesh warping 412 to deform the boundary pixels in an intuitive fashion that balances and smooths out the final image.

The system employs a Moving Least Squares below to calculate an appropriate mesh warping from feature point matching 300 (See FIG. 3) to eliminate the misalignment effects in the transition area.

$$F\_warp = Arg min ( {Sum}_{i} ( {w}_{i} {‖ F\_warp ( x \text{?} , {y}_{1} \text{?} ) \text{?} ( {x}_{2} \text{?} , {y}_{2} \text{?} ) ‖}^{2} )$$

$$\text{?} \text{indicates text missing or illegible when filed}$$

The formula optimizes the mesh warping function F_warp by smoothing out the difference between point (x₂ⁱ, y₂ⁱ) from the main camera image and warped point (x₁ⁱ, y₁ⁱ) from the auxiliary camera image. Wᵢ is a weight for each pixel. The image prior to the local alignment 414 will have rough mismatches due to the rigid pair matching. But after local alignment using mesh warping 416, the resultant image will have smoother lines.

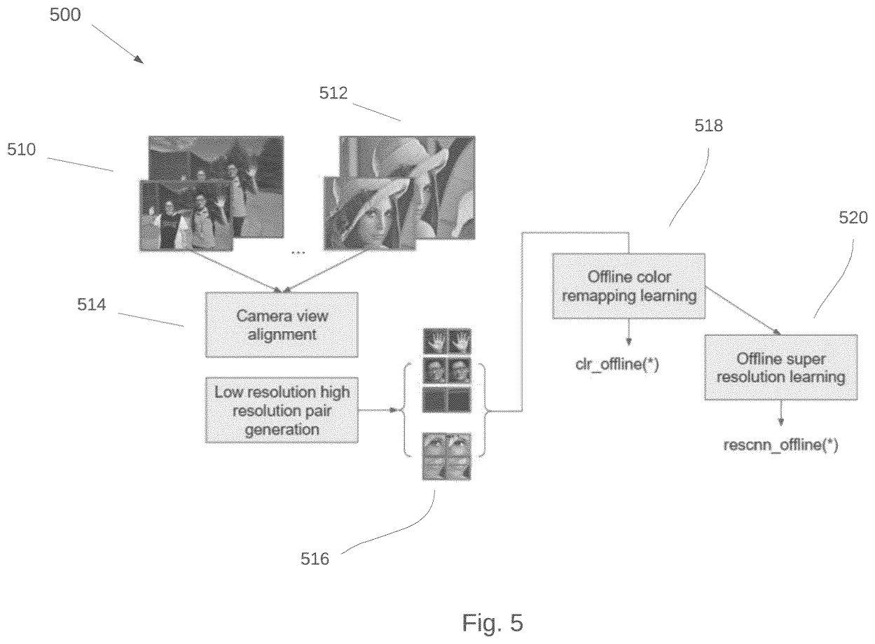

FIG. 5 is an example of the offline compensation model including color compensation and frequency compensation. Due to the differences in camera specifications, the color and resolution between the main camera and the auxiliary wide camera will need to be adjusted. The offline compensations model 500 includes both an offline color remapping function 518 and an offline super resolution function 520. The system first receives images from the main camera and auxiliary wide camera to compare the color 512 and resolution frequency 510. The camera view alignment 514 creates feature point pairs 516 between the images. This will result in corresponding points of low resolution/high resolution as well as low color quality/high color quality. These matched pairs 516 are then used as training data for the system. Optionally, the system can be trained on RGB color space. Optionally, the system can be trained on HSV color space. For example, the data is then used to train the color remapping function 518 to compensate for the color difference between the source image to the target image as formulated below.

$$H\_ \text{?} S\_ \text{?} V \text{?} = clr\_offline ( H\_ \text{?} S\_ \text{?} V\_ \text{?} )$$

$$\text{?} \text{indicates text missing or illegible when filed}$$

Unlike the Red/Green/Blue color model, which use primary colors, the current system uses the Hue/Saturation/Value (HSV) model which is closer to how humans perceive color. It has three components: hue, saturation, and value. This color space describes colors, hue or tint, in terms of their shade, saturation, and their brightness value. This color scheme better represents how people relate to colors than the RGB color model does because it takes into account contrast and brightness between the colors instead of assuming a constant value. Using the pairs, the function determines the target HSV space from source HSV color space. This will allow the system to calculate an average color mapping function between pairs to be applied to the entire image of the larger FOV auxiliary wide camera. This results in an image with a larger FOV but with the higher color quality of the smaller image from the main camera.

Besides the color remapping function 518, an offline super resolution function 520 is used to compensate the pixel disparity between the lower frequency image from the auxiliary wide camera and the high-frequency main camera image. Pixel frequency/density disparity occurs when comparing images of varying resolutions. While color remapping will fix part of the issue, having a lower pixel frequency will result in a lower-quality, grainy image. This can be resolved using a convolutional neural network.

Convolutional neural networks are deep learning algorithms that are used for the analysis of images. The CNN learns to optimize the filters through automated learning, whereas in traditional algorithms these filters are hard coded into the filter/matrix. This independence using prior knowledge in feature extraction of previous images is a major advantage which allows adaptability as larger data sets allow the CNN to provide a more accurate representation versus a rigid matrix.

Here, the system trains a convolutional neural network (CNN) to learn the mapping between images obtained by a low resolution auxiliary wide camera and images obtained by a higher resolution main camera. The CNN is then used to predict high-resolution frequency information from the main camera image which is missed from low resolution and low-quality input of the auxiliary wide camera image. The high-resolution frequency information is applied to upscale the low resolution FOV image of the auxiliary wide camera which results in an image with a larger FOV and higher resolution frequency. Optionally, a high-frequency compensation function rescnn_offline( ) learnt by CNN network is used to predict high-resolution information which is missed from low resolution and low-quality input (e.g., images obtained by low resolution auxiliary wide camera.

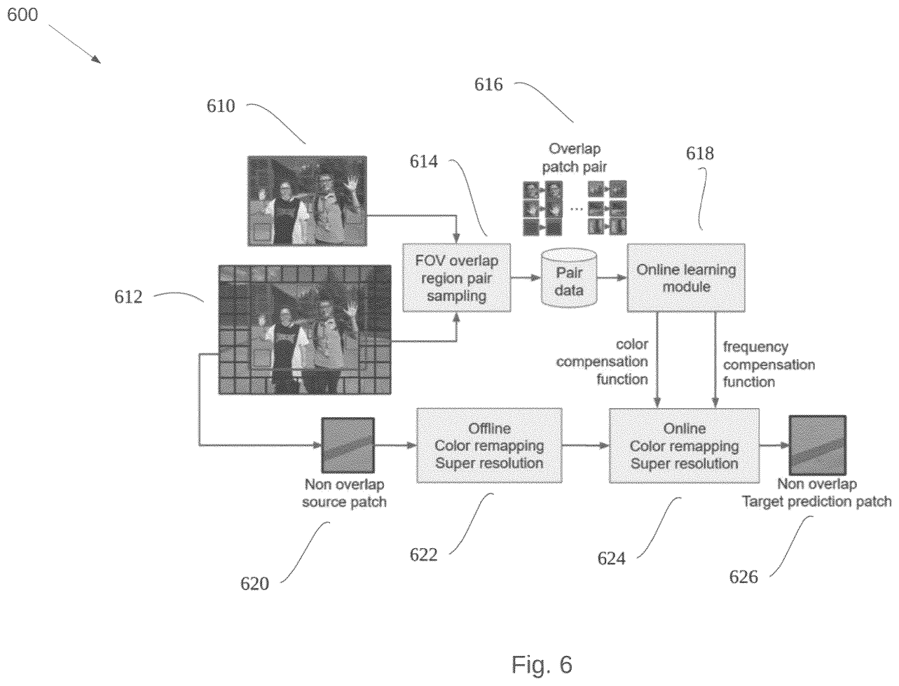

FIG. 6 shows an embodiment of the FOV expansion model process with the corresponding patching from low resolution to high resolution. The FOV expansion model process 600 takes the small FOV main camera image 610 and large FOV auxiliary camera image 612 to determine a FOV overlapping region of interest 614. The system aligns the two images from different cameras to build a pixel to pixel relationship and generates pair 616 which is used as training data for the color compensation and frequency compensation. The source patch 620 is sent to the offline compensation model 622. A color remapping module and a super resolution prediction module are trained on training set which collected offline. However, there are some bias between online capture and offline models of color remapping and high frequency estimated by offline super resolution module.

Therefore, the system compensates the bias using online learning 618. Once the adjustments are applied using the offline compensation model, the system further applies another round of compensation model online 624 to obtain the target quality patch 626. The online color remapping employs a nonlinear regression to model the low frequency relationship between the images, such as color shifting. The online super resolution module is used to compensate the intensity high frequency difference between the two images. The target quality patch 626 is then used to for the resultant final wide FOV target image.

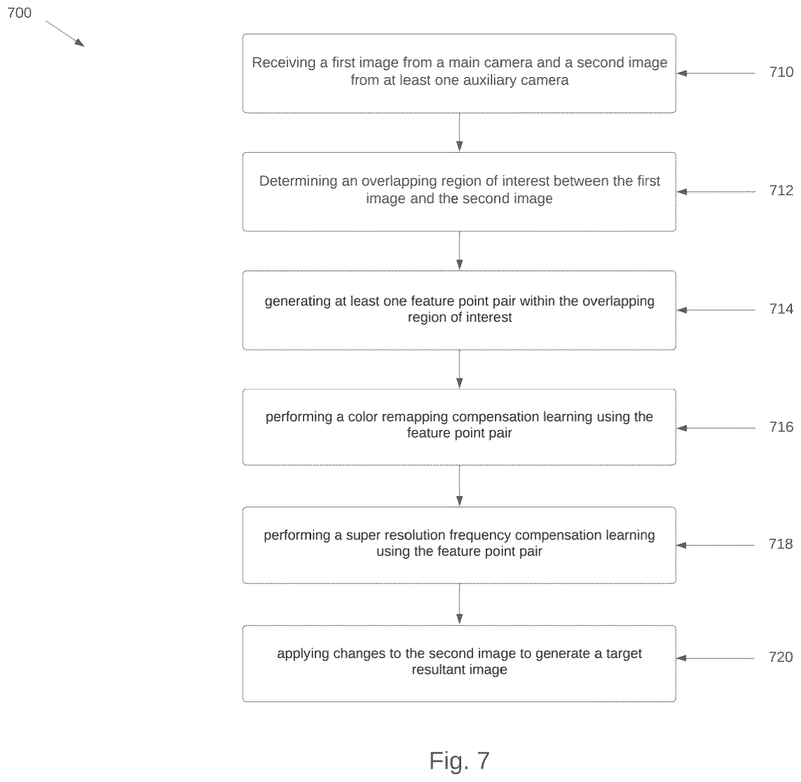

FIG. 7 shows a flowchart of one embodiment of the method for the FOV expansion model. First, images are received from the main camera and at least one auxiliary cameras 710. Once received, there is a determination of the overlapping region of interest between the images 712. Within the overlapping region of interest, feature point pair is generated. Functions are executed to perform color remapping compensation learning 716 and super resolution frequency compensation learning 718. Lastly, the compensation learning is applied to the large FOV image to generate a target resultant image 720.

An additional embodiment relates to a non-transitory computer-readable medium whose storage can be implemented on one or more computer systems for execution to generate one of the samples from one or more low-resolution images of a sample or a program command of a computer-implemented method of multiple high-resolution images. The computer-implemented method can include any step(s) of any method(s) described herein.

Program instructions to implement methods such as those described herein can be stored on the computer-readable medium. The computer-readable medium may be a storage medium, such as a magnetic or optical disc, a magnetic tape, or any other suitable non-transitory computer-readable medium known in the art.

The program instructions can be implemented in any of a variety of ways, including program-based technology, component-based technology, and/or object-oriented technology. For example, you can use ActiveX controls, C++ objects, JavaBeans, Microsoft Foundation Classes (“MFC”), SSE (Streaming SIMD Extensions), or other technologies or methods to implement program instructions as needed.

Although, the invention is described above in terms of various exemplary embodiments and implementations, it should be understood that the various features, aspects, and functionality described in one or more of the individual embodiments are not limited in their applicability to the particular embodiment with which they are described, but instead can be applied, alone or in various combinations, to one or more of the other embodiments of the invention, whether or not such embodiments are described and whether or not such features are presented as being a part of a described embodiment. Thus, the breadth and scope of the present invention should not be limited by any of the above-described exemplary embodiments.

The presence of broadening words and phrases such as “one or more,” “at least,” “but not limited to” or other like phrases in some instances shall not be read to mean that the narrower case is intended or required in instances where such broadening phrases may be absent.

1) A method for field of view extension, comprising:
receiving a first image from a main camera and a second image from at least one auxiliary camera;
determining an overlapping region of interest between the first image and the second image;
generating at least one feature point pair within the overlapping region of interest;
performing a color remapping compensation learning using the feature point pair;
performing a super resolution frequency compensation learning using the feature point pair; and
applying changes to the second image to generate a target resultant image.

2) The method of claim 1, further comprising performing an offline color remapping compensation learning and performing an offline super resolution frequency compensation learning.

3) The method of claim 1, wherein the changes to the second image are based on the color remapping compensation learning and the super resolution frequency compensation learning.

4) The method of claim 1, further comprising performing an online color remapping compensation learning and performing an online super resolution frequency compensation learning.

5) The method of claim 1, further comprising performing a mesh warping alignment using the feature point pair.

6) The method of claim 2 or 4, wherein the offline color remapping compensation learning or the online color remapping compensation learning uses a convolution neural network.

7) The method of claim 2 or 4, wherein the offline super resolution frequency compensation learning or the online super resolution frequency compensation learning uses Hue/Saturation/Value color scheme.

8) The method of claim 1, wherein generating feature point pair includes generating a homography matrix to map the at least one feature point pair.

9) The method of claim 1, wherein a field of view of the first image is smaller than a field of view of the second image.

10) The method of claim 1, wherein a pixel frequency of the first image is higher than a pixel frequency of the second image.

11) A non-transitory computer readable medium including code segments that, when executed by a processor, cause the processor to perform a method for field of view extension, the method comprising:
receiving a first image from a main camera and a second image from at least one auxiliary camera;
determining an overlapping region of interest between the first image and the second image;
generating at least one feature point pair within the overlapping region of interest;
performing a color remapping compensation learning using the feature point pair;
performing a super resolution frequency compensation learning using the feature point pair; and
applying changes to the second image to generate a target resultant image.

12) The non-transitory computer readable medium of claim 11, wherein the field of view of the first image is smaller than the field of view of the second image.

13) The non-transitory computer readable medium of claim 11, wherein a pixel frequency of the first image is higher than the pixel frequency of the second image.

14) The non-transitory computer readable medium of claim 11,
further comprising performing an offline color remapping compensation learning and performing an offline super resolution frequency compensation learning.

15) An apparatus for field of view extension, comprising:
a main camera;
at least one auxiliary wide camera;
one or more processors including:
a comparator for feature pair matching;
a color remapping module; and
a super resolution module.

16) The apparatus of claim 15, wherein the main camera and the auxiliary wide camera have different resolution qualities and field of views.

17) The apparatus of claim 15, wherein the color remapping module and the super resolution module are performed in multiple iterations prior to forming a resultant image.

18) The apparatus of claim 15, wherein the color remapping module and the super resolution module are performed both online and offline.
